(19) United States
(12) Patent Application Publication
(10) Pub. No.: US 2013/0042263 A1
(43) Pub. Date: Feb. 14, 2013

(54) METHOD AND APPARATUS FOR GIVING VIDEO ON DEMAND ASSETS TO SOCIAL NETWORK FRIENDS

(71) Applicant: Jennifer Reynolds, Duluth, GA (US)

(72) Inventor: Jennifer Reynolds, Duluth, GA (US)

(21) Appl. No.: 13/208,950

(22) Filed: Aug. 12, 2011

(51) Int. Cl. H04N 7/16; H04N 7/173

(52) U.S. Cl. 725/23; 725/100

(57) ABSTRACT

A method and apparatus for providing a Video On Demand (VOD) asset as a gift from a plurality of users to a social network friend. A user can discover from a friend's user profile that other users have contributed amounts toward the purchase of a VOD asset as a gift for the friend, and make an additional contribution. A gift server totals the contributions and notifies the friend. If the purchase price is completely paid by the user contributions, the friend can watch the VOD asset free of charge. Alternatively, if the friend decides to watch the VOD asset before the purchase price is completely paid by the user contributions, the friend pays a discounted price equal to the remainder of the purchase price. A billing server proportionally charges the account of each user for their respective contribution.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND

The present invention relates to social networking systems. More particularly, and not by way of limitation, the present invention is directed to an apparatus and method enabling a plurality of social network users to independently contribute monetary sums for purchasing a recommended Video On Demand (VOD) asset for a friend.

Systems have been proposed to allow users to “share” or even give as gifts, entire VOD assets among friends and family members. For example, U.S. Published Patent Application No. 2011/0078714 to Sagayaraj discloses a method of navigating VOD selections, wherein an interface is configured to present a subscriber with the option of sharing VOD assets with other subscribers. Pricing information is provided to the subscriber for any destinations that the subscriber selects for the VOD asset.

U.S. Published Patent Application No. 2009/0132383 to Piepenbrink discloses a system and method, which enables a first user to provide a second user with a gift through a service provider network. The first user may provide an asset such as a ring tone for use on the second user's mobile device. Alternatively, the first user may provide a monetary credit to the second user.

U.S. Published Patent Application No. 2011/0060661 to Chai discloses a system and method for providing a gift media item. A user selects a media item from a catalog of media items and pricing, and sends a selection of the media item and a selection of at least one recipient to an interactive media component. The interactive media component processes the transaction and delivers the selected media item to the recipient.

### SUMMARY

Current solutions for gifting a VOD asset or other multimedia content rely on a single user deciding that one or more other users would enjoy consuming a particular VOD asset. Should the user be incorrect (that is, the VOD asset is never consumed by the gifted user), there is no means of recouping the price paid for the gift. Additionally, such a “one to many” method of gifting or recommending an asset fails to capture the social nature of friend recommendations. If multiple friends were to give the same asset, there is no additional benefit to the gifted user.

Finally, the high cost (the whole price of the asset) to the user providing the gift means that only assets that are very highly recommended are likely to be given in the first place, preventing such a gifting service from being used on a regular basis (and thus promoting or advertising VOD assets).

The present invention provides solutions to the above-mentioned problems. The invention builds upon the social phenomenon that free Internet videos are often widely shared among a large number of users (i.e., they “go viral”) when users share the video (and immediate access to it) among their friends. It would seem that users are more likely to watch one of these free videos, especially if several of their friends have independently recommended it.

In one embodiment, the present invention is directed to a system that enables users to socially “vote” that another user should be given access to a given VOD asset or subscription service at no cost to the gifted user (thus providing a recommendation to the gifted user). Users can see what videos have received votes to give to their friends (without seeing who voted), and can choose to add their own vote to a video. The user receiving the gift can see who voted. Optionally, comments can be left with a vote (either private comments to the gifted user, or public comments) explaining why the gifted user would enjoy the asset.

Each voting user donates a specific amount of money (for example, ¼th the cost of the asset rental or subscription) towards this vote. Once enough users have voted (i.e., covered the cost of the gift), the receiving user has access to the asset. A voting user can vote multiple times, or at a chosen amount (if, for example, the voting user wishes to give the entire asset to a friend).

If the amount donated by voting users is not enough to pay for the asset, the receiving user may purchase the asset/service directly, with a discount equal to the amount donated by the receiving user's friends. If the receiving user rejects the gift, or a predefined amount of time passes without the receiving user consuming the gifted asset, the contributions from all the voting users may be refunded. Alternatively, the voting users are not charged for their contributions until the receiving user consumes the gifted asset.

Such voting interfaces may be implemented in a cable Set Top Box (STB) or a mobile application/webpage tied to a user's cable account.

In a particular embodiment, the present invention is directed to a method of providing a VOD asset having a purchase price as a gift from a plurality of users to a social network friend utilizing a cable STB. The method includes the steps of a first user utilizing the STB to navigate to a database profile for the social network friend, wherein the profile indicates the VOD asset is a pending gift for the friend, and indicates that one or more other users have contributed amounts toward the purchase price, wherein each contributed amount is less than the purchase price of the VOD asset and the total of the contributed amounts is less than the purchase price of the VOD asset. The method also includes the first user utilizing the STB to send a gift request to a gift server, the gift request identifying the VOD asset and indicating that the first user will also contribute an amount less than the purchase price of the VOD asset toward the purchase price as a gift for the social network friend.

In another embodiment, the invention is directed to a method of providing a VOD asset at a discounted price to a first user of a cable television network. The method includes the step of receiving by a gift server, a gift request from a second user of the network, the gift request identifying the VOD asset and indicating that the second user will contribute an amount less than the purchase price of the VOD asset toward the purchase price of the VOD asset as a gift for the first user. The method also includes the steps of the gift server receiving a request from the first user to watch the VOD asset; the gift server prompting the first user to pay the remainder of the purchase price of the VOD asset; the gift server receiving from the social network friend, an offer to pay the remainder of the purchase price; a VOD server streaming the VOD asset to a cable Set Top Box (STB) registered to the first user; and a billing server charging financial accounts of the users according to the amount each user contributed toward the purchase price of the VOD asset, wherein the first user pays a discounted price equal to the purchase price of the VOD asset minus the contribution of the second user.

In another embodiment, the invention is directed to a method of redeeming a gift of a VOD asset. The method includes the steps of sending a notification from a gift server to a mobile device of a first user, the notification indicating that a gift has been purchased through contributions from a plurality of social network friends of the first user; the first user utilizing the mobile device to navigate to a database profile for the first user, wherein the profile identifies the gift as the VOD asset; the first user selecting to watch the VOD asset; and a billing server charging financial accounts of the social network friends according to the amount each friend contributed toward the purchase price of the VOD asset.

In another embodiment, the invention is directed to an apparatus for providing a VOD asset having a purchase price as a gift from a plurality of users to a social network friend. The apparatus includes a database of user profiles configured to store for each user, information identifying VOD assets for which other users have contributed amounts toward the purchase price, wherein a user profile for the social network friend identifies the VOD asset and the amounts contributed by the plurality of users toward the purchase price. The apparatus also includes an access device registered to each of the users, each access device configured to enable a registered user to navigate to the database profile for the social network friend and to make an additional contribution toward the purchase price of the VOD asset. A gift server is configured to calculate a total of the contributions and to notify the social network friend when the total of the contributions equals the purchase price of the VOD asset. A cable STB is registered to the social network friend, and a VOD server is configured to stream the VOD asset to the STB upon receiving a request from the social network friend to watch the VOD asset. A billing server is configured to charge a financial account of each user for each user's respective contribution toward the purchase price.

The present invention provides a number of advantages over existing VOD systems and social networks. First, users are made aware of content their friends think they might like, thus increasing the value of the VOD or subscription service to the users. Rather than having the problem of “1000 channels and nothing to watch”, users are constantly aware of quality programming that fits their interests. Second, users are given a more accurate idea of how much they will like the gifted VOD asset or service. If a number of their friends recommend it, there is a higher likelihood they will like it, than if just one friend recommends it. Third, users are more likely to consume content that is free or discounted (i.e., paid for by their friends), than something they would have to decide to purchase themselves. This causes more VOD content to be consumed than would otherwise be consumed due to recommendations alone.

Fourth, the social nature of voting (and providing successful recommendations) is entertaining in and of itself. Users are more likely to consume content on their own to see if their friends would like it. Fifth, VOD assets or subscriptions are provided the chance to go “viral” as the assets gain traction among users (similar to how popular free Internet videos gain their popularity through messages among friends with links to play the video). Sixth, the low cost of recommending an asset (potentially zero if the recommendation is ignored or rejected, and only a fraction of the full price if accepted and multiple friends contribute) means that users are more likely to make many recommendations to their friends. The fact that there is a potential cost at all, however, will encourage each recommendation to be for quality content rather than junk or spam.

### BRIEF DESCRIPTION OF THE DRAWINGS

In the following section, the invention will be described with reference to exemplary embodiments illustrated in the figures, in which:

FIG. 1 is a simplified block diagram of an exemplary embodiment of the apparatus of the present invention;

FIG. 2 is a flow chart of an exemplary embodiment of a method of sending a VOD gift to a friend utilizing a cable Set Top Box (STB);

FIG. 3 is a flow chart of an exemplary embodiment of a method of receiving a VOD gift from one or more friends utilizing a cable STB;

FIG. 4 is a flow chart of an exemplary embodiment of a method of receiving a discount for a VOD gift from one or more friends utilizing a cable STB;

FIG. 5 is a flow chart of an exemplary embodiment of a method of rejecting a VOD gift from one or more friends utilizing a cable STB; and

FIG. 6 is a flow chart of an exemplary embodiment of a method of receiving a VOD gift from one or more friends utilizing a mobile application/website.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. Additionally, it should be understood that the invention can be implemented in hardware or in a combination of hardware processor(s) and computer program instructions stored on a non-transitory storage medium.

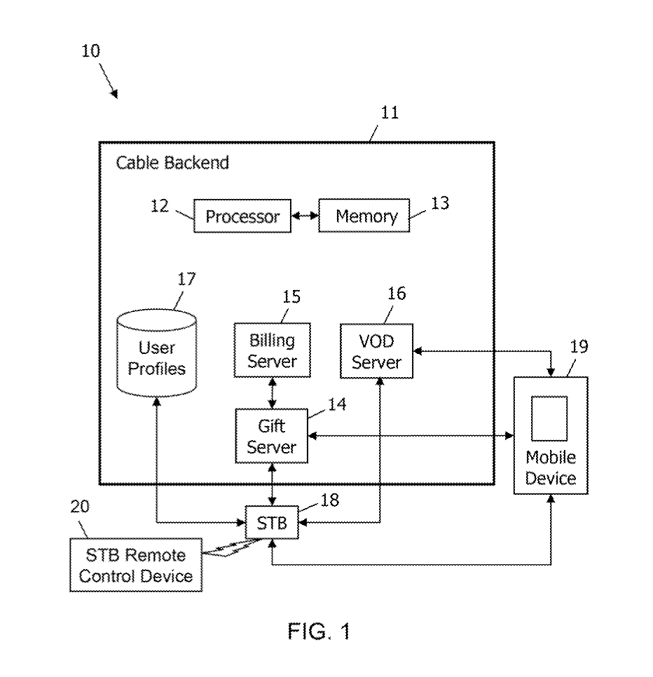

FIG. 1 is a simplified block diagram of an exemplary embodiment of the apparatus 10 of the present invention. A Cable Backend 11 includes one or more processors 12 and non-transitory memories 13 for storing computer program instructions. The processor controls the Cable Backend when the computer program instructions are executed. It should be understood that the other components of the apparatus may also include one or more processors and memory devices within them, but for simplification, such processors and memories are not shown.

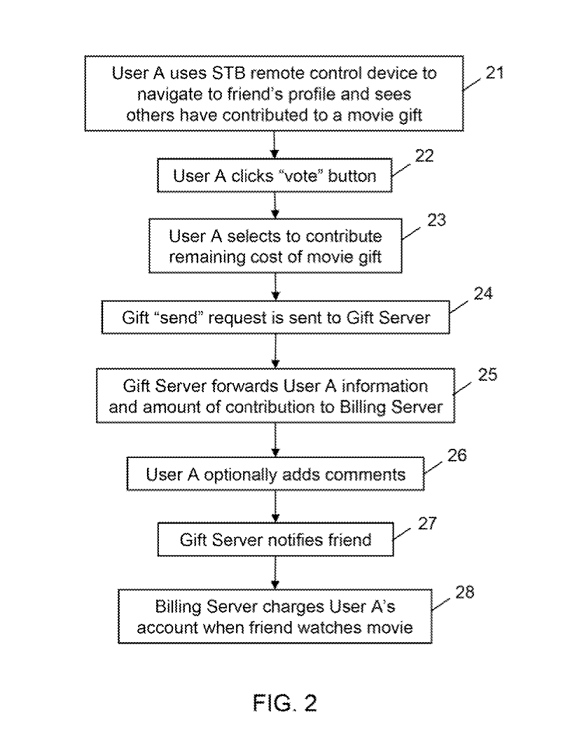

The Cable Backend 11 also includes a Gift Server 14, a Billing Server 15, a VOD Server 16, and a database of user profiles 17. These various components communicate with each other and externally with a cable Set Top Box (STB) 18 and a mobile computing device 19 such as, for example, a mobile phone. A user may utilize an STB remote control device 20 to control the STB and to navigate to various menus and screens displayed on a connected television (not shown). The operation of the apparatus will now be explained by referring to FIGS. 2-6.

FIG. 2 is a flow chart of an exemplary embodiment of a method of sending a VOD gift to a friend utilizing the cable STB 18. At step 21, User A uses the STB remote control device 20 to navigate using the STB to a given friend's profile stored in the database 17. User A sees pending gifts in the friend's profile. One such pending gift may be, for example, a popular action movie for which two other users (anonymous to User A) have contributed half the cost. User A agrees that the friend would enjoy the movie, and decides to contribute the final amount of the cost. At step 22, User A uses the STB remote control device to click a ‘vote’ button. At step 23, User A selects the remaining half of the cost as the amount to contribute. At step 24, a gift “send” request is sent to the Gift Server 14, registering User A's intent to contribute to the action movie gift. At step 25, the Gift Server forwards User A's identification information and the amount of User A's contribution to the Billing Server 15. At step 26, User A optionally adds comments, explaining why she thinks the friend will enjoy the movie. At step 27, the Gift Server notifies the friend that he has a gift. At step 28, when the friend begins to watch the movie, the Gift Server notifies the Billing Server, and the Billing Server charges User A's account for her contribution.

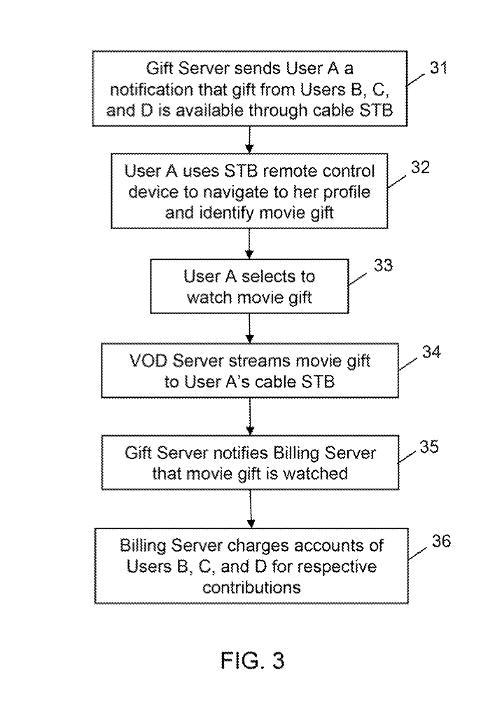

FIG. 3 is a flow chart of an exemplary embodiment of a method of receiving a VOD gift from one or more friends utilizing a cable STB. At step 31, the Gift Server 14 sends User A a notification (through text, email, STB on-screen pop-up notification, or the like) that a gift is available for her through her cable STB. At step 32, User A uses her STB remote control device 20 to navigate to her profile in the database 17. When the profile is received by the STB, User A sees that User B, User C, and User D have purchased a popular comedy movie for her as a gift. At step 33, User A uses the STB remote control device to click a “watch now” button, which sends a play request to the VOD Server 16. At step 34, the VOD Server streams the movie gift to User A's STB 18. At step 35, the Gift Server 14 notifies the Billing Server 15 that the movie is being watched. At step 36, as a result of User A watching the movie, the Billing Server charges the accounts of Users B, C, and D the amounts of their respective contributions.

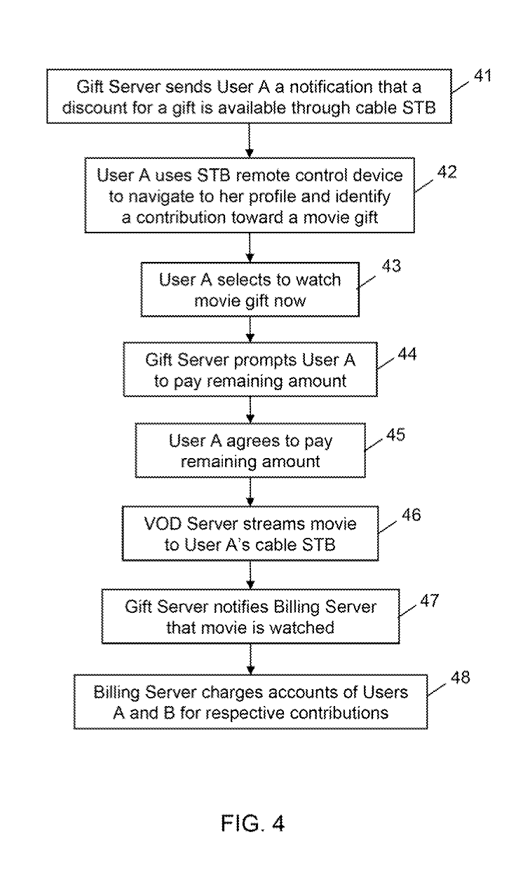

FIG. 4 is a flow chart of an exemplary embodiment of a method of receiving a discount for a VOD gift from one or more friends utilizing a cable STB. At step 41, the Gift Server 14 sends User A a notification (through text, email, STB on-screen pop-up notification, or the like) that a discount is available for her through her cable STB. At step 42, User A uses her STB remote control device 20 to navigate to her profile in the database 17. When the profile is received by the STB, User A sees that User B has contributed money (but not the full amount) towards a popular action movie as a gift for her. User A decides to watch the movie now, rather than waiting to see if anybody else would like to contribute, and at step 43, uses the STB remote control device to click the “watch now” button, which sends a play request to the VOD Server 16. At step 44, the Gift Server 14 prompts User A to pay the remaining amount not covered by User B's contribution. At step 45, User A agrees to pay the remaining amount for her gift. At step 46, the VOD Server 16 begins streaming the movie to User A. User A then watches the movie at a discount (equal to how much User B contributed). At step 47, the Gift Server 14 notifies the Billing Server 15 that the movie is being watched. At step 48, as a result of User A watching the movie, the Billing Server charges the accounts of Users A and B the amounts of their respective contributions.

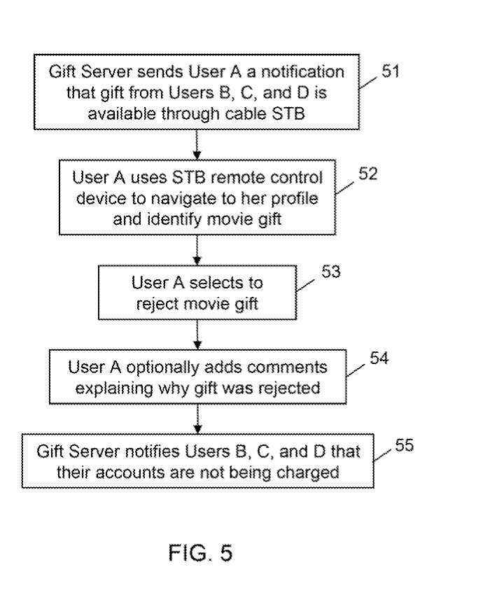

FIG. 5 is a flow chart of an exemplary embodiment of a method of rejecting a VOD gift from one or more friends utilizing a cable STB. At step 51, the Gift Server 14 sends User A a notification (through text, email, STB on-screen pop-up notification, or the like) that a gift is available for her through her cable STB. At step 52, User A uses her STB remote control device 20 to navigate to her profile in the database 17. When the profile is received by the STB, User A sees that Users B, C, and D have contributed money towards a movie that User A is not interested in (maybe she has already seen it, or it is not to her taste). At step 53, User A clicks a “Reject Gift” button (or alternatively allows the time on the gift to expire). At step 54, User A may optionally add comments explaining to Users B, C, and D why this gift was rejected. At step 55, the Gift Server 14 may notify Users B, C, and D that their contributions are not being charged to their accounts.

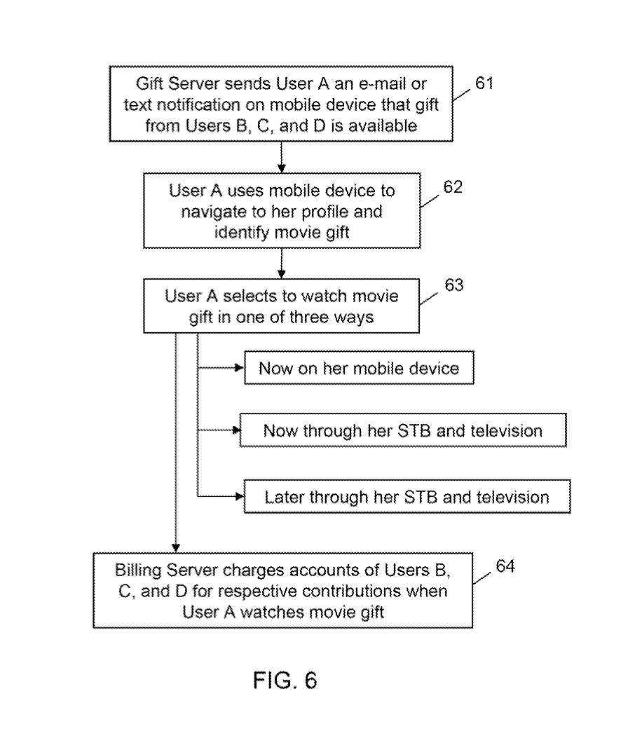

FIG. 6 is a flow chart of an exemplary embodiment of a method of receiving a VOD gift from one or more friends utilizing a mobile application/website. While User Interface (UI) interfaces are generally easier on mobile applications/websites, it requires extra steps or technology in order to consume the content directly on a mobile device. The description below only discusses extra steps or differences from the STB method discussed above. Unless otherwise noted, giving gifts, receiving gifts, rejecting gifts, etc. are the same as the STB embodiments above.

At step 61, the Gift Server 14 sends User A an email or text on her mobile device 19 that a gift is available for her. At step 62, User A navigates to her profile in the database 17. When the profile is received by the mobile device, User A reviews the gift, for example a popular mystery movie. At step 63, User A chooses to play the gift in one of multiple ways:

a. Now, on her mobile device 19 or computer, for example via multiscreen technology.

b. Now, through her STB 18 and television, for example via STB remote technology that enables a computer or mobile device to control an associated registered STB. In this case, the mobile device sends a play request to the VOD Server 16. The VOD Server streams the movie to the registered STB associated with the mobile device and notifies the mobile device. The mobile device then “force tunes” the STB to the channel on which the movie is being streamed.

c. Later, through her STB 18 and television. This option requires her to navigate to the gift movie utilizing her STB remote control device 20 as is normally done, and select it.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of providing a Video On Demand (VOD) asset having a purchase price as a gift from a plurality of users to a social network friend utilizing a cable Set Top Box (STB), the method comprising the steps of:
a first user utilizing the STB to navigate to a database profile for the social network friend, wherein the profile indicates the VOD asset is a pending gift for the friend, and indicates that one or more other users have contributed amounts toward the purchase price, wherein each contributed amount is less than the purchase price of the VOD asset and the total of the contributed amounts is less than the purchase price of the VOD asset; and
the first user utilizing the STB to send a gift request to a gift server, the gift request identifying the VOD asset and indicating that the first user will also contribute an amount less than the purchase price of the VOD asset toward the purchase price as a gift for the social network friend.

2. The method as recited in claim 1, wherein the amount contributed by the first user is the remainder of the purchase price of the VOD asset.

3. The method as recited in claim 2, further comprising a VOD server streaming the VOD asset to a second STB free of charge, wherein the second STB is registered to the social network friend and the VOD server streams the VOD asset upon receiving a request from the social network friend to watch the VOD asset.

4. The method as recited in claim 3, further comprising a billing server charging financial accounts of the first user and the other users according to the amount each user contributed toward the purchase price of the VOD asset.

5. The method as recited in claim 4, wherein the billing server charges the financial accounts of the first user and the other users in response to the social network friend watching the VOD asset.

6. The method as recited in claim 2, wherein the billing server charges the financial account of each user when each user sends a gift request to the gift server indicating a contributed amount, and the gift server notifies the billing server of the gift request.

7. The method as recited in claim 6, further comprising the steps of:
the gift server receiving from the social network friend, an indication that the gift is rejected; and
the billing server refunding each user's contributed amount in response to the social network friend rejecting the gift.

8. The method as recited in claim 6, further comprising the steps of:
the gift server determining that the social network friend did not watch the VOD asset within a defined time period; and
the billing server refunding each user's contributed amount in response to the social network friend not watching the VOD asset within the defined time period.

9. The method as recited in claim 1, wherein the amount contributed by the first user is less than the remainder of the purchase price of the VOD asset.

10. The method as recited in claim 9, further comprising the steps of:
the gift server receiving a request from the social network friend to watch the VOD asset;
the gift server prompting the social network friend to pay the remainder of the purchase price of the VOD asset; and
the gift server receiving from the social network friend, an offer to pay the remainder of the purchase price.

11. The method as recited in claim 10, further comprising the steps of:
the gift server notifying a VOD server of the request from the social network friend to watch the VOD asset; and
the VOD server streaming the VOD asset to a second STB, wherein the second STB is registered to the social network friend.

12. The method as recited in claim 10, further comprising the steps of:
the gift server notifying a billing server of the amount the social network friend offered to pay, and the amount each user contributed, toward the purchase price of the VOD asset;
the billing server charging financial accounts of the users according to the amount each user contributed toward the purchase price of the VOD asset; and
the billing server charging a financial account of the social network friend a discounted price for the VOD asset, the discounted price equaling the purchase price of the VOD asset minus the total contributions of the users.

13. A method of providing a Video On Demand (VOD) asset at a discounted price to a first user of a cable television network, the method comprising the steps of:
receiving by a gift server, a gift request from a second user of the network, the gift request identifying the VOD asset and indicating that the second user will contribute an amount less than the purchase price of the VOD asset toward the purchase price of the VOD asset as a gift for the first user;
the gift server receiving a request from the first user to watch the VOD asset;
the gift server prompting the first user to pay the remainder of the purchase price of the VOD asset;
the gift server receiving from the social network friend, an offer to pay the remainder of the purchase price;
a VOD server streaming the VOD asset to a cable Set Top Box (STB) registered to the first user; and
a billing server charging financial accounts of the users according to the amount each user contributed toward the purchase price of the VOD asset, wherein the first user pays a discounted price equal to the purchase price of the VOD asset minus the contribution of the second user.

14. The method as recited in claim 13, further comprising the steps of:
the gift server receiving additional gift requests from other users, each gift request identifying the VOD asset and indicating that a different user will contribute an amount less than the purchase price of the VOD asset toward the purchase price of the VOD asset as a gift for the first user; and
the gift server adding the contributed amounts of the second user and the other users to calculate a total discount for the first user.

15. A method of redeeming a gift of a Video On Demand (VOD) asset, the method comprising the steps of:
sending a notification from a gift server to a mobile device of a first user, the notification indicating that a gift has been purchased through contributions from a plurality of social network friends of the first user;
the first user utilizing the mobile device to navigate to a database profile for the first user, wherein the profile identifies the gift as the VOD asset;
the first user selecting to watch the VOD asset; and
a billing server charging financial accounts of the social network friends according to the amount each friend contributed toward the purchase price of the VOD asset.

16. The method as recited in claim 15, wherein the first user selects to watch the VOD asset immediately on the mobile device.

17. The method as recited in claim 15, wherein the first user selects to watch the VOD asset immediately through a cable Set Top Box (STB) registered to the first user.

18. The method as recited in claim 15, wherein the first user selects to watch the VOD asset later through a cable Set Top Box (STB) registered to the first user.

19. An apparatus for providing a Video On Demand (VOD) asset having a purchase price as a gift from a plurality of users to a social network friend, the apparatus comprising:
a database of user profiles for storing for each user, information identifying VOD assets for which other users have contributed amounts toward the purchase price, wherein a user profile for the social network friend identifies the VOD asset and the amounts contributed by the plurality of users toward the purchase price;
an access device registered to each of the users, each access device configured to enable a registered user to navigate to the database profile for the social network friend and to make an additional contribution toward the purchase price of the VOD asset;
a gift server configured to calculate a total of the contributions and to notify the social network friend when the total of the contributions equals the purchase price of the VOD asset;
a cable Set Top Box (STB) registered to the social network friend;
a VOD server configured to stream the VOD asset to the STB upon receiving a request from the social network friend to watch the VOD asset; and
a billing server configured to charge a financial account of each user for each user's respective contribution toward the purchase price.

20. The apparatus as recited in claim 19, wherein the database of user profiles is configured to reveal the identities of contributing users to the social network friend, but not to other contributing users.

21. The apparatus as recited in claim 19, wherein the database of user profiles is configured to store private comments from contributing users directed to the social network friend.

22. The apparatus as recited in claim 19, wherein the database of user profiles is configured to store public comments from contributing users regarding why the VOD asset is recommended for the social network friend.

23. The apparatus as recited in claim 19, wherein the gift server is further configured to notify the social network friend when each contribution is received, wherein if the social network friend requests to watch the VOD asset when the total of the contributions is less than the purchase price of the VOD asset, the gift server is configured to prompt the social network friend to pay the remainder of the purchase price as a discounted price for the VOD asset.

24. The apparatus as recited in claim 19, wherein the billing server is configured to charge the financial account of each user only when the social network friend watches the VOD asset.

25. The apparatus as recited in claim 24, wherein the gift server is further configured to receive from the social network user, an indication that the gift is rejected, and to notify the contributing users that the gift has been rejected, wherein the billing server does not charge the financial accounts of the users.

26. The apparatus as recited in claim 19, wherein the billing server is configured to charge the financial account of each user upon notification by the gift server that each contribution has been made, wherein if the social network user later rejects the gift, the billing server refunds the respective contributions to the financial accounts of the users.
